(19) United States
(12) Patent Application Publication
(10) Pub. No.: US 2005/0067300 A1
(43) Pub. Date: Mar. 31, 2005

(54) Electrolysis device for treating a reservoir of water

(75) Inventor: Mario Elmen Tremblay, West Chester, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/941,610

(22) Filed: Sep. 15, 2004

Related U.S. Application Data
(60) Provisional application No. 60/505,895, filed on Sep. 25, 2003.

(51) Int. Cl. C02F 1/461

(52) U.S. Cl. 205/742; 422/23; 204/225

(57) ABSTRACT

A self-powered self-contained electrolysis device, for placement into a reservoir of a contaminated electrolytic solution, such as water, containing halide ion, such as chloride ion, to electrolyze the water, thereby disinfecting or sterilizing the contaminated reservoir of water. Contaminated reservoirs of water can be water containers filled with river water and other outdoor sources, or can be contaminated municipal water held in kitchen containers, cooling systems, water tanks, cisterns, etc. The self-contained body allows the electrolysis device to float on or remain self-contained in the reservoir water. Preferred devices are small and portable, and comprise reliably productive electrolysis cells that are powered by batteries. A means for propulsion of the device can also be provided, and is preferably a pump that pumps the water through the electrolysis cell.

### CROSS REFERENCE TO RELATED APPLICATION

This application claims the benefit of U.S. Provisional Application No. 60/505,895, filed Sep. 25, 2003.

### FIELD OF THE INVENTION

This invention relates to an electrolysis device having an electrolysis cell for treating a reservoir of water or other electrolyte solution.

### BACKGROUND OF THE INVENTION

The worldwide population uses water daily for drinking, cooking, bathing, cleaning, and other personal uses. In many countries, the supply of water is made relatively safe for consumption or for contact with the body through municipal water treatments. Such municipal treatment usually uses chemicals, such as chlorine or ozone, to treat the water to destroy harmful microorganisms in the water. Nevertheless, these supplies are not completely effective at killing all of the bacteria and other pathogens, and can become contaminated with bacteria and other pathogens as a result of faulty treatment operations. In a variety of circumstances, these contaminants must be removed or neutralized before the water can be used. For example, in many medical applications and in the manufacture of certain electronic components, extremely pure water is required. As a more common example, any harmful contaminants must be removed from water before consumption or use for bathing. Despite modern water purification means, the general population is at risk, and in particular infants and persons with compromised immune systems are at considerable risk. In many countries, a substantial proportion of the population of this planet does not have “running water; that is, a supply of reasonably fresh, safe water that can be delivered into the community, or into the individual homes, and can only obtain a supply of water for drinking, cooking, bathing, etc. from local water sources, such as lakes, ponds, streams, rivers, wells, cisterns, springs, etc. Even the freshest of these water sources has some level of harmful bacteria and other pathogens. Very often these water sources can be highly polluted and can contain extremely high level of harmful microorganisms and pathogens. There are deadly consequences associated with exposure to contaminated water, caused by increasing population densities, increasingly scarce water resources, and often no community water treatment utilities. It is common for sources of drinking water to be in close proximity to human and animal waste, such that microbiological contamination is a major health concern. As a result of waterborne microbiological contamination, an estimated six million people die worldwide each year, half of which are children under 5 years of age.

In 1987, the U.S. Environmental Protection Agency (EPA) introduced the “Guide Standard and Protocol for Testing Microbiological Water Purifiers”. The protocol establishes minimum requirements regarding the performance of drinking water treatment systems that are designed to reduce specific health related contaminants in public or private water supplies. The requirements are that the effluent from a water supply source exhibits 99.99% (or equivalently, 4 log) removal of viruses and 99.9999% (or equivalently, 6 log) removal of bacteria against a challenge. Because of the prevalence of Escherichia coli (E. coli, bacterium) in water supplies, and the risks associated with its consumption, this microorganism is used as the bacterium in the majority of studies.

It is known that the containers used for holding the water supply can also become contaminated with bacteria and other pathogens, such that, even when fresh, safe water is placed for holding into the container, the water can become contaminated (or re-contaminated) by the container itself. Furthermore, the user's containers of the water, such as baths, tubs, drinking water pitchers, etc. can become contaminated and can retain a biofilm on the surface of the container, even though cleansed with water and common detergents.

An effective means for treating water and other electrolyte solutions to kill microorganisms and other pathogens therein employs an electrolysis cell whereby the solution (e.g., water) passes in between or over a set of electrodes across which an electrical current is applied. The electrical current passing between the electrodes and through the solution can convert chloride ions (residual or added, such as by adding salt, NaCl) into one or more chlorine biocidal agents that are effective in killing bacteria, viruses, parasites, protozoa, molds, spores, and other pathogens in the solution. Examples of electrolysis cells and methods for electrolyzing water are disclosed in U.S. Pat. No. 3,616,355 (Themy et al., issued Oct. 26, 1971, U.S. Pat. No. 4,062,754 (Eibl), issued Dec. 13, 1977, U.S. Pat. No. 4,100,052 (Stillman), issued Jul. 11, 1978, U.S. Pat. No. 4,761,208 (Gram et al.), issued Aug. 2, 1988, U.S. Pat. No. 5,313,589 (Hawley), issued May 24, 1994, and U.S. Pat. No. 5,954,939 (Kanekuni et al.), issued Sep. 21, 1999.

Much of the world's water supply for cooking, bathing, drinking, cleaning, and recreation (for example, swimming pool and spa water) is contained as a reservoir of water, such as tanks, tubs, water pitchers, as well as ponds, cisterns, lakes, and others. Therefore, of specific interest are reservoirs of water contaminated with harmful bacteria and other unhealthy microorganisms, or that are contained within reservoir containers (tubs, pitchers, and the like) that are contaminated with these same pathogens. Various attempts have been made to treat such reservoirs of water, but none have been completely effective. It is known to treat swimming pools for the growth of algae and for potential microorganism with only limited success. U.S. Pat. No. 4,337,136 issued to Dahlgren (Jun. 29, 1982) discloses a device having a pair of silver-copper electrodes depending from the bottom of a floating container, and containing a 12-volt battery. The device sacrifices silver ions from the electrodes into the water that can allegedly attack bacteria in the water. U.S. Pat. No. 5,013,417, issued to Judd, Jr. (May 7, 1991) discloses a device that floats inside the skimmer of a pool, having attached to its bottom a pair of copper/silver disks that are spaced apart sufficiently for unobstructed flow of water between the disks. The device can be powered by photovoltaic cells or batteries. Other examples of floating devices having sacrificial anodes to treat swimming pool water are disclosed in U.S. Pat. No. 5,059,296 (issued Oct. 22, 1991) and U.S. Pat. No. 5,085,7532 (issued Feb. 4, 1992), which disclose floating solar powered water purifiers having a purification cell below the surface of the water to be treated. None of these references teaches an electrolysis device that is reliably and completely effective in killing microorganisms in the reservoir of water.

Another means of treating a reservoir of water is described in WO 00/71783, published Nov. 30, 2000, describes a portable disinfection device having an annular electrolysis cell in which a batch of brine solution is electrolyzed to form an electrolyzed brine solution for use in sterilizing a substance or a container of untreated water. The portable disinfection device is described as a “pen” purification device for personal water purification.

Despite the many advances in the technology of electrolyzing waters and other electrolytic solutions, there remains a need for more effective, more efficient, more portable, and more affordable electrolysis devices and techniques for the treatment of the world's water supplies for safe and healthy living.

Objects of the present invention include: providing an improved electrolysis device for electrolyzing water and other electrolytic solutions stored or handled in containers, tanks, and any other reservoir (including small ponds, cisterns, etc.); providing an electrolysis device that is both effective in electrolyzing water from the reservoir, and safe to persons who use or benefit from the device, including children and infants; providing a self-powered electrolysis device for treating a reservoir of water, which can operate away from (and in the absence of) conventional household electrical currents; providing an electrolysis device that is self-contained and self-powered, that both effectively and reliably electrolyzes water, and is affordable to consumers in most income brackets; providing an electrolysis device that can effectively kill bacteria and other pathogens in the water source, as well as bacteria and other pathogens that are resident on the surfaces of the water container and that can contaminate, or re-contaminate, the water source; providing an electrolysis device that is mobile within the reservoir of water or can ensure the necessary diffusion of biocidal active via movement, propulsion, or water jets, to provide the biocidal benefits throughout the reservoir of water; providing an improved electrolysis device having a buoyant and/or self-contained body and an electrolysis cell having close-spaced electrodes that provide efficient conversion of chloride ions in the source water into biocidal oxidant agents at low power requirements; providing a method for sterilizing a reservoir of water or electrolysis solution which can continue to sterilize the reservoir in case of a re-contamination from an outside source; and providing an improved method of bathing infants and small children that virtually eliminates harmful and unhealthy microorganisms and other pathogens from the bathing water.

### SUMMARY OF THE INVENTION

The invention provides a self-powered electrolysis device, for placement into a reservoir of an electrolytic solution containing chloride ions, to electrolyze the electrolytic solution, comprising:
(1) a self-contained body,
(2) an electrolysis cell comprising a pair of electrodes defining a cell passage formed there between through which the electrolytic solution can flow, the cell passage having an inlet and an outlet, wherein the cell inlet is in fluid communication with the reservoir electrolytic solution, and wherein the cell passage forms a gap between the pair of electrodes having a gap spacing between about 0.1 mm to about 5.0 mm, and
(3) an electrical current supply for applying electrical current between the pair of electrodes.

The electrolysis device can further comprise a means for pumping the reservoir water through the cell passage,

The invention also provides a self-powered, self-propelled electrolysis device, for placement into a reservoir of an electrolytic solution containing chloride ions to electrolyze the electrolytic solution, comprising:
(1) a self-contained body,
(2) an electrolysis cell comprising at least a pair of electrodes defining a cell passage formed there between through which the electrolytic solution can flow, the cell passage having an inlet and an outlet, wherein the cell inlet is in fluid communication with the reservoir electrolytic solution,
(3) an electrical current supply for applying electrical current between the electrodes, and
(4) a means of propulsion for moving the self-contained electrolysis device within the reservoir of water.

Preferably the electrolysis cell is contained within the self-contained body of the self-propelled self-contained device. The electrolysis cell can also be positioned on an outside, submerged surface of the self-contained body, whereby reservoir water passes into the inlet of the electrolysis cell as the self-contained body moves within the reservoir of water. The self-propelled self-contained electrolysis device can further comprise a means for pumping the reservoir water through the cell passage, which can be the same means as the propulsion means. In a preferred embodiment, the propulsion means comprises a rotating impeller driven by an electric motor that is powered by an electrical current supply. Preferably, the self-contained body can be positively buoyant in the electrolytic solution, whereby the device is at least partially exposed above the surface of the reservoir electrolytic solution.

The invention also includes a method of disinfecting a reservoir of an electrolytic solution containing halide ions, and optionally a reservoir which can be repeatedly contaminated with microorganisms, with a self-powered electrolysis device, comprising:
1) providing a reservoir of contaminated water;
2) treating at least a portion of the reservoir water with the electrolysis device, thereby disinfecting the water; and, optionally
3) re-treating at least a portion of the reservoir water with the electrolysis device, in response to a re-contamination of the water with microorganisms, thereby re-disinfecting the water.

A preferred method continuously treats the reservoir of electrolytic solution with the electrolysis device, thereby preventing a re-contamination of the reservoir. A preferred method treats the reservoir solution by passing at least a portion of the reservoir solution to the electrolysis device, electrolyzing the portion of reservoir water in an electrolysis cell of the electrolysis device, thereby forming an effluent of electrolyzed water comprising a quantity of mixed oxidant material, discharging the effluent into the reservoir of water, and dispersing the effluent throughout the reservoir of water, thereby disinfecting the reservoir. An optional method of the present invention provides a local source of halide ions that is mixed with the portion of the reservoir solution passing to the electrolysis cell, and electrolyzed in the electrolysis cell, thereby forming an effluent of electrolyzed water comprising a quantity of mixed oxidant material that is greater than a quantity of mixed oxidant material formed by electrolyzing the portion of the reservoir solution only.

### BRIEF DESCRIPTION OF THE DRAWINGS

The various advantages of the present invention will become apparent to skilled artisans after studying the following specification and by reference to the drawings in which:

FIG. 1 shows a planar electrolysis cell used in an electrolysis device of the present invention.

FIG. 2 shows an alternative electrolysis cell used in an electrolysis device of the present invention.

FIG. 3 shows yet another alternative electrolysis cell used in an electrolysis device of the present invention.

FIG. 4 shows one embodiment of a device of the present invention, comprising the electrolysis cell of FIG. 1 taken through line 4-4.

FIG. 5 shows another embodiment of a device of the present invention, comprising the electrolysis cell of FIG. 3 taken through line 5-5.

### DETAILED DESCRIPTION OF THE INVENTION

Definitions

“Self-powered” means that a device comprises the source of electrical or other power necessary for the defined functions of the device, which can include, but are not limited to, the electrical current supply for the electrolysis cell, the power for any pumping means, the power for any propulsion means, the power for any indication or control means, etc.

“Self-contained” means that the device and all its elements are substantially contained as a single article or unit, and do not require physical connection outside the reservoir with external power or propulsion means through wires, tethers, etc.

“Buoyant” means positively buoyant (i.e., the body and/or device will float to the surface of the reservoir electrolytic solution) and neutrally buoyant (i.e., the body and/or device will remain submerged and substantially stationary in the reservoir electrolytic solution). A non-buoyant body and/or device will sink quickly in the reservoir electrolytic solution.

“Fluid communication” means that electrolytic solution can flow between the two objects between which the fluid communication is defined.

“Sterilization” means the destruction al all microbial life, including bacterial spores.

“Disinfection” means the elimination of nearly all microbial forms, but not necessarily all. Disinfection does not ensure overkill and lacks the margin of safety achieved by sterilization.

Electrolytic Solution

In its broadest use in the present invention, an electrolytic solution is any chemically compatible solution that can flow through the passage of the electrolysis cell, and that contains sufficient electrolytes to allow a measurable flow of electricity through the solution. Water, except for deionized water, is a preferred electrolytic solution, and can include: sea water; water from rivers, streams, ponds, lakes, wells, springs, cisterns, etc., mineral water; city or tap water; rain water; and brine solutions. Electrolytic solutions can also include blood, plasma, urine, polar solvents, electrolytic cleaning solutions, beverages, and others. An electrolytic solution of the present invention is chemically compatible if it does not chemically explode, burn, rapidly evaporate, or if it does not rapidly corrode, dissolve, or otherwise render the electrolysis device unsafe or inoperative, in its intended use.

Preferred are electrolytic solutions that contain a residual amount of halide ions, including chloride, fluoride, bromide, and iodide, and more preferably chloride ions. During electrolysis, which is described in more detail below, the halide ions can be converted to biocidally-effective mixed oxidants that include various halide oxidants. Preferred devices of the present invention comprise an electrolysis cell that is very effective in converting the reservoir solution containing low levels of residual halide ions into an effluent solution (that is, the electrolyzed solution that is discharged from the outlet of the cell) containing a higher level of the biocidal mixed oxidants. Such reservoir solutions containing residual halide ions can comprise 35,000 ppm (sea water) or less, preferably less than 1,000 ppm, more preferably less than about 400 ppm, and most preferably less than 200 ppm, of halide ions. Of course, reservoir solutions containing the higher levels of residual halide ions also are more efficiently converted into an effluent solution having even larger amounts of the mixed oxidants. This is due in part because the conductivity of the electrolysis solution increases with the concentration of halide ions, thereby enabling a greater current flow across the passage gap between the pair of electrodes under a constant voltage potential. In general, to produce the same amount of mixed oxidants at a fixed power (current and voltage potential), an electrolysis solution having a higher concentration of halide ions will require a substantially larger gap spacing, compared to an electrolysis solution having lower concentrations of the halide ions.

Preferably the electrolytic solution has a specific conductivity ρ of greater than 100 μS/cm, preferably more than 150 μS/cm, even more preferably more than 250 μS/cm, and most preferably more than 500 μS/cm.

Body

The devices of the present invention have a body into, or onto, which the other elements are positioned. A body can be any open or closed object that can contain one or more of the other elements of the electrolysis device, including an electrolysis cell, an electrical current supply, a pumping means, a propulsion means, and a local source of halide ions. The body can be made of any material that is compatible with the reservoir electrolysis solution, and the device's use. For use in water, the body is preferably made of plastics, including PVC, polyethylene, polypropylene, other polyolefins, foam plastics, rubberized plastics, and Styrofoam; metals including tin, aluminum, steel, and others; and can even use wood or paper board including coated paperboard, depending upon the use. Preferred are durable, resilient plastics that can help to protect the internal components from external impact and forces that might otherwise damage them.

The body can be made in almost any shape, including spheres and ovals, cubes, and rectilinear shapes. A preferred shape is that of a play toy, such as a boat, duck, whale, or other shape, for use in an infant bath tub.

Preferred devices comprise a housing that is sealed or is sealable to prevent electrolytic solution from entering the housing, except as intended (such as through the inlet port). The body is preferably a closed body having a confined space within the body to contain one or more of the other components of the electrolysis device, and is most preferable water-proof to prevent the solution (e.g., water) from the reservoir from entering into the body (except through the passage of the electrolysis cell), thereby preventing short circuiting or other damage to an electrical current supply, and any pumping means, propulsion means, etc. The body can have an opening through its outer surface through which electrolysis solution can pass through to the electrolysis cell contained therein. The body can have at least one sealed or sealable compartment therein into which the electrical current supply, such as a set of dry cell batteries, are placed. The body can have one or more removable covers for openings, through which components, such as batteries, can be removed, installed, or replaced, and which can be made liquid sealable. The sealed or sealable compartment within the body serves to prevent liquid, such as the electrolysis solution, from entering, and ensures buoyancy. The internal volume of the body should be sized to provide both a space for the components, and air space sufficient to make the device buoyant, taking into account the combined weight of the body and its components. For positively buoyant devices, a target maximum submersion of the device is about 80%, which means the volume of the device that is below the surface of the water should be 80% or less. The weight of the device should be 80% or less of the weight in water that the volume of the device will occupy. Small devices that are more convenient to handle can advantageously use miniaturized pumps, electrolysis cells, and battery sets that deliver high productivity and efficiency.

When the electrolysis cell is positioned inside the body, the cell inlet is placed into fluid communication with the reservoir solution via at least one opening in the outer surface of the body, and a tube or duct that connects the outer opening with the inlet of the cell. Likewise, the body can have an outlet opening that is in fluid communication between the outlet of the cell and the reservoir.

Electrolysis Cell

The electrolysis cell is the most important functional component of the device. The electrolysis cell generates biocidal agents by passing electrical current through an electrolytic solution that is positioned within or flows through the cell, and more particularly, from the halide ions contained in, or added to, the reservoir electrolytic solution. The electrolysis cell comprises at least a pair of electrodes, between which passes the electrolysis solution. A cell passage is the space between the pair of electrodes, and has the shape defined by the confronting surfaces of the pair of electrodes. The cell passage has a cell gap, which is the perpendicular distance between the two confronting electrodes. Ordinarily, the cell gap will be substantially constant across the confronting surfaces of the electrodes.

Generally, the electrolysis cell will have one, or more, inlet openings, in fluid communication with each cell passage, and one, or more, outlet openings, also in fluid communication with the passage. The inlet opening is also in fluid communication with the reservoir solution, such that the reservoir solution can flow into the inlet, through the passage, and from the outlet of the electrolysis cell. The effluent solution (the electrolyzed solution exiting from the passage) is typically returned to reservoir, thereby treating the reservoir solution with the generated biocidal agents.

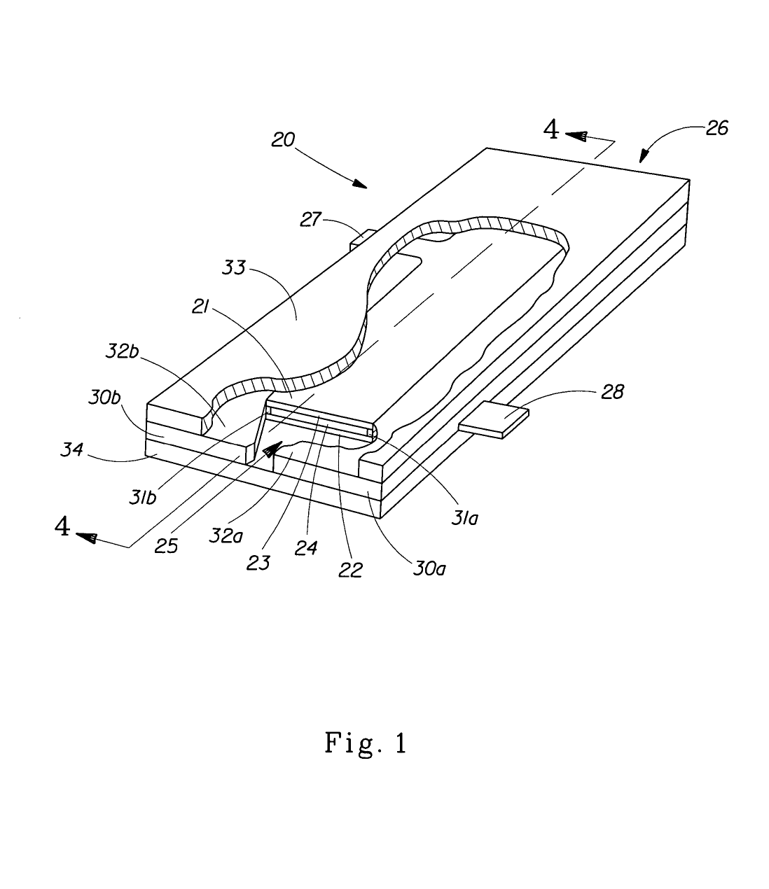

FIG. 1 shows a planar electrolysis cell 20 that can be used in an electrolysis device of the present invention. The cell comprises an anode 21 electrode and a cathode 22 electrode. The electrodes are held a fixed distance away from one another by a pair of opposed non-conductive electrode holders 30a and 30b having electrode spacers 31a and 31b that space the confronting longitudinal edges of the anode and cathode apart by a spacing gap 23, thereby forming a passage 24 between the electrodes. The passage 24 has a cell inlet 25 and an opposed cell outlet 26 through which the electrolysis solution can pass into and out of the cell. Reservoir solution flows into the cell between an expanding flow inlet formed between the extended inlet portions 32a and 32b of the electrode holders 30a and 30b, and into the cell passage 24. The assembly of the anode and cathode, and the opposed plate holders are held tightly together between non-conductive anode cover 33 (shown partially cut away) and cathode cover 34 by a retaining means (not shown) that can comprise non-conductive, water-proof adhesive, bolts, or other means, thereby restricting exposure of the two electrodes only to electrolysis solution that flows through the passage 24. Anode lead 27 and cathode lead 28 extend laterally and sealably through channels made in the electrode holders 30b and 30a, respectively.

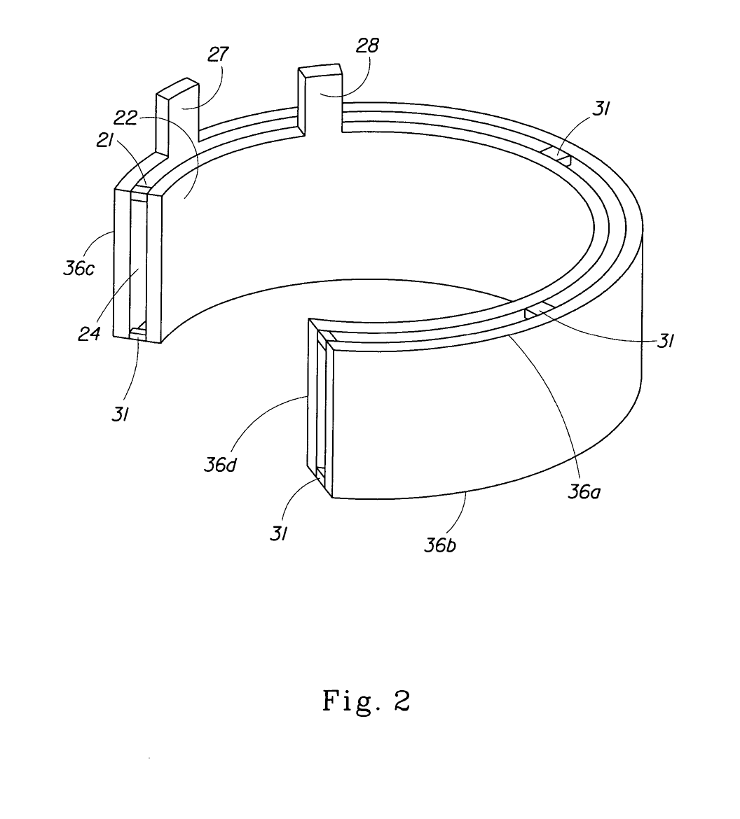

FIG. 2 shows an alternative electrolysis cell of the present invention. The cell comprises a curled anode 21 and a curled cathode 22. The outer surface of the cathode 22 and the inner surface of the curled anode 21 are confronting and form a passage 24 there between. The electrodes are formed to provide a uniform gap spacing between the electrodes across their entire confronting surfaces. Electrolytic solution can flow into and out of the passage of the cell through any of the openings into the cell along edges 36b, 36c, and 36d. Alternatively, the cell plates can be sealed along the edge 36b to provide a cell having an inlet and outlet openings 36c or 36d. The electrodes are held in their confronting spaced position by a plurality of electrode spacers 31 positioned along the periphery of the passage 24. Usually, a planar base for the cell (not shown) is attached to the curled edges 36a of the electrodes, which also helps to stabilize the electrodes from flexing and separating from one another. Anode lead 27 and cathode lead 28 are used to attach the electrical current supply to the cell.

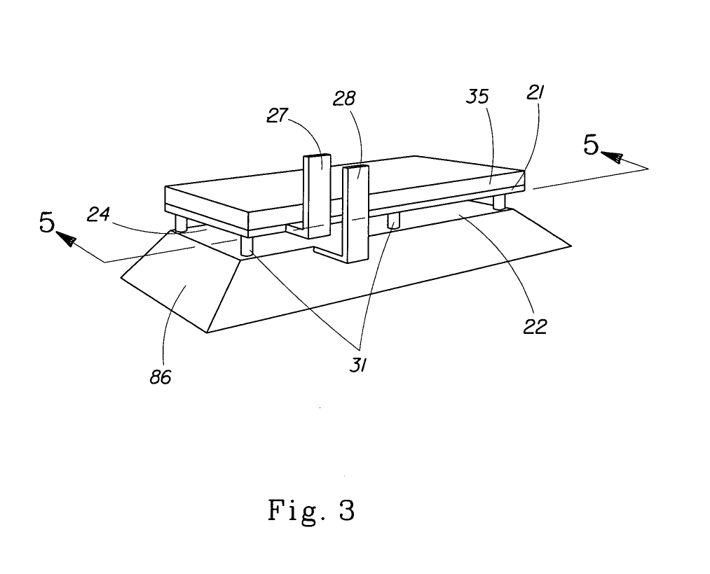

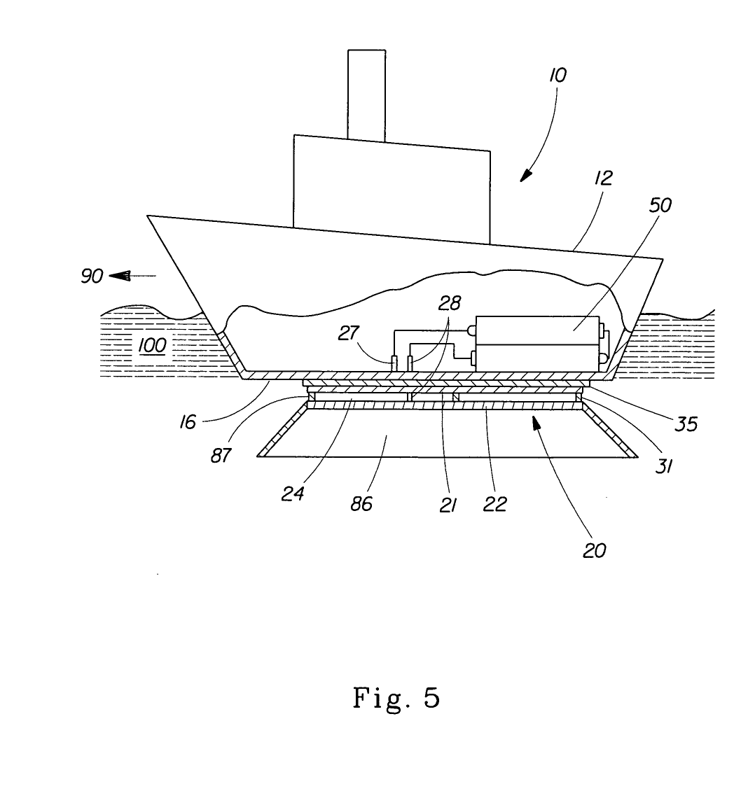

Another preferred cell embodiment can comprise a pair of electrodes open to the flow of solution in from and out toward any direction. An example of such an electrical cell is shown for illustration in FIG. 3, wherein spacers 31 are positioned along the periphery of the passage 24 to maintain the gap spacing between the electrodes. So long as the gap spacing is sufficient to provide a flow of liquid through the electrolyzed cell passage, sufficient amounts of mixed oxidant agents can be produced to effectively treat the reservoir solution. Although the cell in FIG. 3 is shown with rectangular electrodes, the electrodes can be provided in other shapes, including circles, oval and squares. A funnel member 86 is shown affixed to the electrolysis cell, adjacent to the cathode 22, although it can be affixed to either or both electrodes. In FIG. 3, a base 35 is attached to the upper surface of the anode 21, which can then be easily affixed to an outer surface of the body 16. The funnel member 86 is also shown attached to the entire periphery of the cathode, but can be attached to one side, or to two or more sides. The funnel member helps to force liquid from the reservoir that enters the expanded funnel opening 87 and into the inlet of the cell as the cell, which is mounted to a body 16 and connected to an electrical current supply 50, is moved or propelled through the reservoir (as shown by direction 90 in FIG. 5), or as reservoir solution is moved past the cell.

Electrodes

An electrode can generally have any shape that can effectively conduct electricity through an electrolytic solution between itself and another electrode, and can include a planar electrode, an annular electrode, a spring-type electrode, and a porous electrode. Another preferred electrode forms are curled plates such as shown in FIG. 2. Generally, the anode and cathode electrodes, as well as any ancillary electrodes positioned there between, are shaped and positioned such that there is a uniform gap between a cathode and an anode electrode pair. Consequently, a pair of planar electrodes will be preferably co-extensive and parallel to, or separated by a constant gap spacing from, one another.

Planar electrodes, such as shown in FIG. 1, are commonly used. The aspect ratio of an electrolysis cell employing planar electrodes is defined by the ratio of the length of the anode along the flow path of the solution, to the width of the anode, transverse to the flow path. Generally, the aspect ratio of the electrolysis cell is between 0.2 and 10, though more preferably is between 0.1 and 6, and most preferably between 2 and 4.

The pair of electrodes, both the anode and the cathode, are generally metallic, conductive materials, though non-metallic conducting materials, such as carbon, can also be used. The materials of the anode and the cathode can be the same, but can advantageously be different. The electrodes are preferably dimensionally and spacially stable, to avoid excessive bending, flexing, warping, and gapping of the electrodes during use, thereby maintaining a constant gap spacing between the confronting electrodes. To minimize corrosion, chemical resistant metals are preferably used. Examples of suitable electrodes are disclosed in U.S. Pat. No. 3,632,498 and U.S. Pat. No. 3,771,385. Preferred anode metals are stainless steel, platinum, palladium, iridium, ruthenium, as well as iron, nickel and chromium, and alloys and metal oxides thereof. More preferred are electrodes made of a valve metal such as titanium, tantalum, aluminum, zirconium, tungsten or alloys thereof, which are coated or layered with a Group VIII metal that is preferably selected from platinum, iridium, and ruthenium, and oxides and alloys thereof. Particularly preferred is an anode made of titanium core and coated with, or layered with, ruthenium, ruthenium oxide, iridium, iridium oxide, and mixtures thereof, having a thickness of at least 0.1 micron, preferably at least 0.3 micron. The electrode can have a thickness of about 5 mm or less, though more preferably about 0.1 mm to about 2 mm.

For many applications, a metal foil having a thickness of about 0.03 mm to about 0.3 mm can be used. Foil electrodes should be made stable in the cell so that they do not warp or flex in response to the flow of liquids through the passage that can interfere with proper electrolysis operation. The use of foil electrodes is particularly advantageous when the cost of the device must be minimized, or when the lifespan of the electrolysis device is expected or intended to be short, generally about one year or less. Foil electrodes can be made of any of the metals described above, and are preferably attached as a laminate to a less expensive base metal, such as tantalum, stainless steel, and others.

The electrolysis cell of this embodiment can be positioned inside the body, on the outside surface of the body, or partially on the outside and the inside. Preferably, the cell is positioned inside the body of the device to avoid contact by the electrodes and the circuitry with the hands or body of the user or with other non-compatible objects in the environment.

The electrolysis cell can also comprise a batch-type cell that electrolyses a volume of the electrolytic solution (such as water). The batch-type cell comprises a batch chamber having a pair of electrodes. The batch chamber is filled with water from the reservoir, which is then electrolyzed and returned back to the reservoir. The electrodes preferably comprise an outer annular anode and a concentric inner cathode. Alternatively, the cell can comprise a batch-continuous-type cell that electrolyses a volume of water, a portion of which flows into the chamber and a portion of which flows out of the chamber during the step of electrolyzing the water contained within the chamber. Preferably, the reservoir water is mixed with a local source of halide ions to generate proportionally greater amounts of mixed oxidants. An example of a suitable batch cell, along with a halide salt supply and electrical circuitry to control the electrolysis of the salt solution, are disclosed in WO 00/71783-A1, published Nov. 30, 2000, incorporated herein by reference.

Electrical Current Supply

Operation of the electrolysis cell requires an electrical current supply to provide a flow of current across the passage of flowing water, between the electrodes. A preferred electrical current supply is a battery or set of batteries, preferably selected from an alkaline, lithium, silver oxide, manganese oxide, or carbon zinc battery. The batteries can have a nominal voltage potential of 1.5 volts, 3 volts, 4.5 volts, 6 volts, or any other voltage that meets the power requirements of the electrolysis device. Most preferred are common-type batteries such as “AA” size, “AAA” size, “C” size, and “D” size batteries having a voltage potential of 1.5 V. Two or more batteries can be wired in series (to add their voltage potentials) or in parallel (to add their current capacities), or both (to increase both the potential and the current). Rechargable batteries are advantageously employed.

An alternative electrical current supply can be a rectifier of household current, which converts 100-230 volt AC current to the required DC current. Another alternative is a solar cell that can convert (and store) solar power into electrical power. Solar-powered photovoltaic panels can be used advantageously when the power requirements of the electrolysis cell draws currents below 2000 milliamps across voltage potentials between 1.5 and 9 volts.

In one embodiment, the electrolysis cell can comprise a single pair of electrodes having the anode connected to the positive lead and the cathode connected to the negative lead of the battery or batteries. A series of two or more electrodes, or two or more cells (generally, a pair of electrodes) can be wired to the electrical current source. Arranging the cells in parallel, by connecting each cell anode to the positive terminal(s) and each cell cathode to the negative terminal(s), provides that the same electrical potential (voltage) from the electrical current supply will pass across each cell, and that the total current of the electrical current supply will be divided (evenly or unevenly) between the two or more electrode pairs of cells. Arranging two cells (for example) in series, by connecting the first cell anode to the positive terminal, the first cell cathode to the second cell anode, and the second cell cathode to the negative terminal, provides that the same electrical current from the electrical current supply will pass across each cell, and that the total voltage potential of the electrical current supply will be divided (evenly or unevenly) between the two cells.

The electrical current supply can further comprise a circuit for periodically reversing the output polarity of the battery or batteries in order to maintain a high level of electrical efficacy over time. The polarity reversal minimizes or prevents the deposit of scale and the plating of any changed chemical species onto the electrode surfaces.

In addition to the electrolysis cell and any pumping means or propulsion means, the electric current supply can also provide power optional control circuits, including indicating light(s), to control the timing and duration of the electrical operations of the device. The control system can automatically shut off the current to the electrolysis cell, pumping means, or propulsion means, or any combination thereof, after a period of time, and can operate the indicator lights to indicate when the device is operating, when the device should be turned off, when the reservoir water is sterilized safe, and when the battery life runs low. Alternatively, the current to the electrolysis cell and other electrical components can simply be wired in series to an on-off switch, with an indicator light to show that power is being delivered to the components.

Operation of the Electrolysis Cell

The chemistry of the conversion of halide ions to biocidal agents proceeds as electrical energy is applied between the pair of electrodes and through the electrolytic solution. Since chloride is the most prevalent halide in most waters, the description of the electrolysis cell chemistry and operation will be described with respect to converting chloride to chlorine, although it should be understood that other halides, especially bromide and iodide, would function and respond similarly to chloride. Similarly, since water (such as tap water) is a particularly preferred electrolytic solution, the description below will describe the use of water having a residual amount of chloride ions, although it should be understood that other electrolytic solutions can be used.

Water containing residual amounts of chloride ions is electrolyzed as it passes between the anode (the positively charged electrode of the pair) and the cathode (the negatively charged electrode). Two of the reactions that occur at the anode electrode are set forth below as equations 1 and 2.
2Cl⁻→Cl₂+2e⁻ (1)
H₂O→1/2O₂+2H⁺+2e⁻ (2)

One of the reactions that occurs at the cathode is set forth as equation 3.
2H₂O+2e⁻→H₂+2 OH⁻ (3)

Furthermore, chlorine molecules can be converted to hypochlorous acid and hypochlorite ions as set forth in equations 4 and 5, respectively.
Cl₂+H₂O→HOCl+Cl⁻+H⁺ (4)
HOCl→OCl⁻+H⁺ (5)

The chlorine gas that is generated dissolves or diffuses into the water to generate free chlorine in the form of hypochlorous acid, hypochlorous acid ions, and hypochlorite ions. It is believed that other various mixed oxidant species that can form include chlorine dioxide (ClO₂), other chloro-oxides molecules, oxide molecules including ozone, hydrogen oxide (H₂O₂) and free radicals (oxygen singlet, hydroxyl radicals) and ions thereof. Such mixed oxidants are demonstrated and described in U.S. Pat. No. 3,616,355 (issued Oct. 26, 1971) and U.S. Pat. No. 4,761,208 (issued Aug. 2, 1988). These types of mixed oxidants are very effective biocidal agents, but have very short lifespans, lasting from a fraction of a second to minutes under ordinary, ambient conditions. Consequently, generating these biocidal agents at the point of use ensures the most effective use of the biocidal species. Furthermore, generating the biocidal agents continuously throughout the use of the solution, such as in a bathtub, is highly effective in avoiding any re-contamination of the water by other objects that are associated with the bath, such as play toys, sponges, and wash cloths, or from soil on the body of the infant or bather.

For effective treatment of the harmful microorganisms in the reservoir solution, including those in the solution passing through the electrolysis cell, as well as the reservoir solution that is treated by the residual mixed oxidants in cell effluent, the concentration of mixed oxidants in the electrolysis cell effluent, as measured by the DPD method, is at least 0.1 mg per liter (about 0.1 ppm) of electrolysis cell effluent, preferably 0.2 mg per liter (about 0.2 ppm), more preferably at least 1 mg per liter (about 1 ppm), and most preferably at least 5 mg per liter (about 5 ppm).

An important consideration for small, portable electrolysis devices, and particlarly for those devices of the present invention, is the productivity of the electrical power of the device. When battery power is used, it is important to provide the greatest possible production of mixed oxidant agents for each watt of power consumed. This ensures long battery life, greater consumer convenience, smaller and more portable devices, and greater consumer value.

The productivity of an electrolysis cell is expressed by equation I,
η=(CCl*Q)/(I*V) (I)
wherein:
η units are micrograms of chlorine per minute, per watt of power used;
CCl is the concentration of the generated chlorine equivalent, as determined by the DPD Method, in milligrams per liter (mg/l);
I is the electric current in amps;
Q is the volumetric flow rate in milliliters per minute (ml/m); and
V is electric potential across the cell in volts.

The productivity η of the electroytic device used in accordance with the present invention is typically greater than 100, and more typically greater than 250. In preferred embodiments of the electrolysis cell, the productivity η is more than about 500, and more preferably more than about 1000, when the reservoir water has a concentration of halogen ions of more than 0.001% (10 ppm) and less than 0.1%. Preferably, the electrolysis device has the above-described efficiencies when the electric current is between about 100 milliamps and about 2000 milliamps, with typical current densities of between about 5 milliamps/cm² and 100 milliamps/cm² of exposed anode electrode surface, and more preferably between about 10 milliamps and 50 milliamps/cm². Since the electrical potentials required to convert chloride to chlorine is about 1.36V, a voltage potential greater than 1.36V across the passage will generate a proportionally greater amount of mixed oxidants from the chloride ions. The voltage potential maintained between any pair of anode and cathode electrodes must be generally greater than 1.36V, and generally less than about 12 volts, and is preferably between about 2.0V and 6V, and more preferably between about 3V and 4.5V. For self-powered self-contained devices, batteries are the preferred electrical current sources. To achieve the extended life from a set of batteries, the device is preferably designed to draw a total power of 20 watts or less, preferably 5 watts or less, more preferably 2.5 watts or less, and most preferably 1 watt or less, across the electrode pairs of the cell.

Generally, the electrolysis cell has a cell gap spacing greater than about 0.05 mm, preferably greater than 0.10 mm, more preferably greater than 0.15 mm, and most preferably greater than about 0.20 mm, and a cell gap spacing less than about 5 mm, preferably less than about 2.0 mm, more preferably less than about 0.80 mm, and most preferably less than about 0.50 mm. The more preferable cell gap spacings are for use with electrolytic solutions that contain a concentration of halide ions of less than about 200 ppm, and a specific conductivity p of greater than about 250 μS/cm.

The residence time between the inlet and outlet of the anode and cathode pair is generally less than 10 seconds and preferably is less than 5 seconds, in more preferred embodiments, between about 0.01 seconds and about 1.5 seconds, and most preferably between 0.05 and about 0.5 seconds. The residence time can be approximated by dividing the total volume of the passage between the anode and cathode pair by the average flow rate of water through the electrolysis cell.

Operation and effectiveness of the electrolysis device requires that the reservoir solution passes through the electrolysis cell in a quantity sufficient to generate an effective production of the biocidal mixed oxidants for the intended purpose. In general, without some means of moving the reservoir solution through the cell, as opposed to just filling the cell, low levels of the mixed oxidants will be produced. Water from the reservoir can be moved through the electrolysis cell by pumping through the cell, by movement of the device body through the reservoir, such as by hand, by propulsion, or by pulling or pushing the device through the reservoir by a tether or at the end of a handle. Alternatively, the device can be placed into an area of the reservoir where there is water flow sufficient to pass through the cell.

Operation in a Reservoir of Electrolytic Solution

In the operation of the present electrolysis device in a reservoir, it is not necessary that the entire volume of reservoir water pass through the electrolysis cell. Because of the high biocidal activity of the high concentration of mixed oxidants in the effluent of the electrolysis cell (a concentration substantially higher than needed to destroy the population of microorganisms in the reservoir solution), a water volume less that the total volume of the reservoir will need to pass through the device to ensure that all the microorganisms in the reservoir solution have been destroyed. Generally only about 25% or less, and preferably only 10% or less, of the total volume of the reservoir will need to be passed through the electrolysis cell.

The electrolysis device of the present invention can neutralize at least about 4 log, and preferable at least about 6 log, and more preferably at least about 8 log of the microorganisms in the electrolysis solution that passes through the electrolysis device. The log neutralization is intended to refer to the difference between the live microorganisms that enter the electrolysis device and those that exit the electrolysis device. For example, an 8 log neutralization is intended to refer to a situation where no live microorganisms are present in the water at the exit of the electrolysis device when 10⁸ live microorganisms were present in the water of the inlet to the electrolysis device. Similarly, the electrolysis device of the present invention can neutralize at least about 4 log, and preferable at least about 6 log, and more preferably at least about 8 log of the microorganisms in the reservoir of electrolysis solution that has been treated with the electrolysis device.

Pumping Means

The device is preferably provided with a pump means for pumping the reservoir water through the cell passage. The pumping means can provide three functions: to move electrolytic solution from the reservoir through the electrolysis cell, where mixed oxidants can be generated from halide ions when electric current is passed through the cell; to expel and disperse the effluent solution containing the mixed oxidants back into the reservoir; and to provide movement (propulsion) of the device through the reservoir in response to the force of the effluent solution leaving the device.

A preferred pumping means comprises a pump having a rotating impeller, mounted inside the self-contained body, and having a pump inlet in fluid communication with the reservoir solution, and a pump outlet in fluid communication with the inlet of the electrolysis cell. Self-priming pumps, such as peristalsis pumps, can be used. The pump is preferably driven by an electric, direct drive motor that is powered by a battery, although other power means to drive the pump, such as mechanical wind-up springs or photovoltaic panels can be used. Preferably, the pump electric motor draws power of the same voltage potential as the electrolysis cell.

The direction of the discharge of the effluent can affect both the dispersion of the mixed oxidants into the reservoir, and the movement of the device through the reservoir. For dispersion purposes, a discharge angle of about 45° downward from horizontal has been found optimum. For propulsion purposes, a discharge angle of from 0° to about 30° works well. Straight-ahead propulsion is generally achieved by directing the discharge outward and straight backward in a direction opposite the center of gravity of the device (hereinafter, the “straight back direction”). Preferred is a propulsion means that turns the device in sweeping circles, achieved by angling the discharge from between about 10° to about 80° from the straight-back direction.

The pump can have a throughput of between 0.05 liters solution per minute, up to about 10 liters per minute. Higher pumping rates are possible, depending upon the size of the self-contained device, and the capacity of any electric current supply. For devices that are easily portable and powered by conventional alkaline batteries, a preferred pumping capacity is between 0.1 and 5 liters per minute, and more preferably between 0.2 and 2 liters per minute.

While the entire volume of the pump means can be directed fully through the electrolysis cell, the pump discharge can be divided, with one portion passing through the electrolysis cell and the remaining portion by-passing the electrolysis cell. This enables a device to deliver a certain mass rate of electrolytic solution through the electrolysis cell, while using the by-passing portion of the pumped solution for propelling the device.

Alternatively, an electrolysis device can comprise a pumping means which discharges through the electrolysis cell, with a portion of the discharged effluent from the electrolysis cell being recirculated back to the inlet of the pump, to provide a continuous recycle of a portion of the effluent back through the inlet of the cell. This arrangement can increase the concentration of the resulting mixed oxides in the effluent discharged from the electrolysis cell.

Local Source of Halide Ion

An optional embodiment of the present invention includes an electrolysis device comprising a local source of halide ions, and a means for delivering the local source of halide ions to a portion of the reservoir water in fluid communication with the cell inlet. This embodiment is advantageously used in those situations when the reservoir water has a very low concentration, or even no, halide ions, thereby increasing the production of mixed oxidants in the effluent as compared to the production of mixed oxidants from the reservoir solution alone. Preferably, all the local source of halide ion passes through the electrolysis cell, to maximize the conversion of the local source of halide ion to mixed oxidants, and to limit adding salts to the reservoir generally. The local source of halide ions can supplement the ordinary levels of halide ion in many water sources, such as tap water, to generate extraordinarily high concentrations of mixed oxidants in the effluent.

The local source of halide ions can be a concentrated brine solution, a salt tablet in fluid contact with the reservoir of electrolytic solution, or both. A preferred localized source of halide ions is a solid form, such as a pill or tablet, of halide salt, such as sodium chloride (common salt). The means for delivering the local source of halide ions can comprise a salt chamber comprising the halide salt, preferably a pill of tablet, through which a portion of the reservoir water will pass, thereby dissolving a portion of the halide salt into the portion of water. The salted portion of water then passes into the electrolysis cell. The salt chamber can comprise a salt void that is formed in the self-contained body and positioned in fluid communication with the portion of water that will pass through the electrolysis cell.

A brine solution can be provided within a brine chamber that is position in fluid communication with the inlet port of the electrolysis cell via a tube, such that a flow of brine solution will be induced through the tube by venturi suction in response to the flow of water through the inlet port, whereby a constant proportion of brine solution is delivered.

Other halide salts with a substantially lower solubility in water can be advantageously used to control the rate of dissolution of halide salt. Preferred salts for use as a solid form of the local source of halide ion are the less soluble salts, such as calcium chloride, magnesium chloride, potassium chloride and ammonium chloride. The pill can also be formulated with other organic and inorganic materials to control the rate of dissolution of the sodium chloride. Preferred is a slow dissolving salt tablet, to release sufficient halide ions to effect the conversion of an effective amount of mixed oxidant biocidal agents. The release rate halide ion is typically between 0.01 to 0.3 mg halide ion for each liter of reservoir water treated. The halide pill can be a simple admixture of the salt with the dissolution restricting materials, which can be selected from various well-known encapsulating materials.

The following specific embodiments of the present invention are intended to exemplify, but in no way limit, the operation of the present invention.

Embodiment I

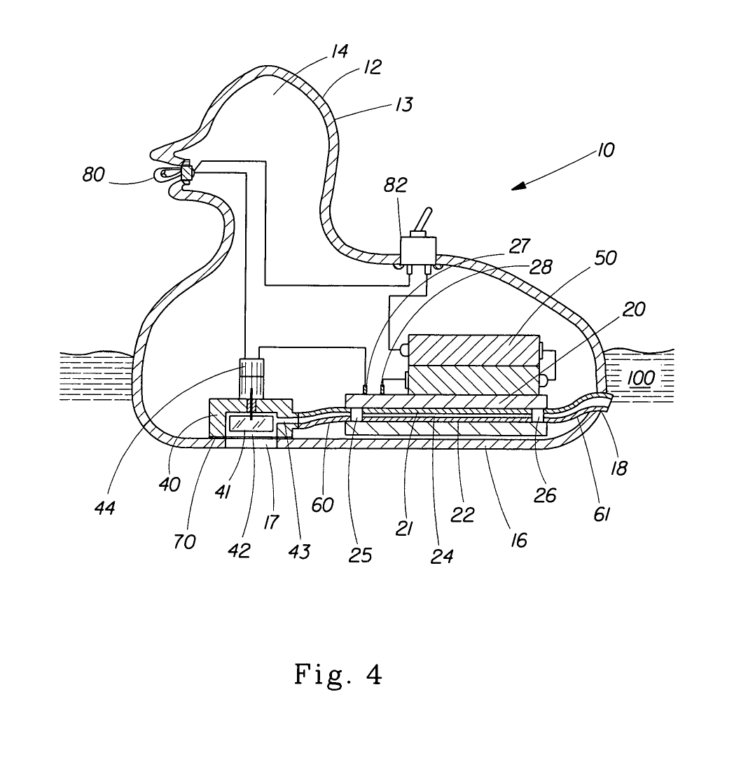

An example of a self-contained, self-propelled electrolysis device is shown in cross section in FIG. 4. The duck electrolysis device 10 has a buoyant body 12 made into the form of a duck. The body has a substantially continuous outer surface 13 and a hollow interior 14. The body is molded from a rubberized PVC plastic. Within the interior of the body, mounted to the base 16 is an electrically-driven motor 44 (model RE260, LMP Inc., Jersey City, N.J.) that drives a pump 40 having impeller 41 (model IMPELR-S, Swampworks Mfg., Springfield, Mo.). The inlet 42 to the pump is positioned directly against an inlet opening 17 in the base 16 of the body to provide fluid communication between the reservoir 100 of water and the inlet 42 to the pump. The periphery of the pump outboard of the pump inlet is sealed to the base 16 with a water-proof adhesive 70 to prevent any leakage of reservoir water into the body of the device. The discharge 43 of the pump is connected via ¼ inch Tygon tubing 60 to the inlet 25 of an electrolysis cell 20 mounted within the self-contained body. An electrolysis cell of the type shown in FIG. 1 is shown in FIG. 4 in cross section taken through line 4-4 of FIG. 1. The electrolysis cell 20 has an anode plate 21 made of titanium with a coating of ruthenium oxide (1.45 mm thick) and measuring 7.2 cm long in the direction of fluid flow, and 2.7 cm wide (transverse to the fluid flow path), and a cathode plate 22 made of stainless steel (1.45 mm thick), having the same dimensions as the anode and positioned parallel to and coterminous with the anode. The anode and the cathode are separated by a gap spacing of 0.20 mm, and define a passage 24 there between. The outlet 26 of the electrolysis cell discharges to one end of a ¼ inch Tygon tube 61, with the other end of the tube penetrating through a rear port 18 in the duck body near the rear end of the base 16, which is sealed with water-proof adhesive at the penetration opening in the base to prevent leakage of the reservoir water into the body. The anode lead 27 and the cathode lead 28 are connected via wiring to the positive and negative terminals, respectively, of an electrical current supply 50, consisting of two “AA” alkaline batteries (each 1.5V) arranged in series to provide a 3.0V potential electrical supply. The aforementioned pump motor 44 is also wired with the batteries, in parallel to and downstream from the electrolysis cell, to receive the same 3 volt potential. With a 3 volt potential, the electrolysis cell draws about 0.20 amps, while the motor 44 draws about 200 milliamps in driving the pump 40 to pump 400 ml per minute of water through the electrolysis cell 20. In addition, an indicator lamp 80 (model 160-1127-ND, Digi-Key) is wired in line between the pump motor and the positive terminal of the batteries, to glow when current flows. This serves as an indicator to the user that the electrolysis device is functioning. Further, an on-off switch 82 is wired just downstream from the positive terminal to turn on and shut off the current to the pump motor 44 and the electrolysis cell 20. The indicator lamp 80 and the on-off switch 82 are positioned to extend through the body as shown in FIG. 4.

A 20-liter capacity plastic tub of water is filled with about 10 liters of water from a stream that contains E. coli bacteria. The stream water has a residual chloride level of 80 ppm. The water temperature is adjusted to 28° C. to make the water comfortable for an infant. A 110 ml water sample is collected (Sample A) of the before-treatment water, in a sterile 125 ml polypropylene bottle with cap for a baseline reading of microbial contamination and residual chlorine in the water.

An additional 20 cm length of Tygon tube is attached to the rear port 18, for sampling the electrolyzed water discharged from the device. The duck electrolysis device is placed floating onto the surface of the tub water, with the sampling tube discharge end positioned outside the plastic tub, toward a drain. The switch is pushed to the “on” position, and the device operates (i.e., it pumps reservoir water through the electrolysis cell with current passing between the electrodes). After 30 seconds, a 110 ml water sample is collected (Sample B) of the effluent discharged directly from the device, into a sterile 125 ml polypropylene bottle. The switch is pushed to the “off” position, and the sampling tube is removed from the rear port 18 of the device.

The pump switch is again pushed to the “on” position. The pump immediately begins pumping reservoir water through the electrolysis cell, and from the rear port and out into the reservoir of water, thereby providing forward propulsion to the buoyant device. The pump and electrolysis cell operate for 5 minutes, during which time the buoyant duck device propels itself about the surface of the water in the bath tub. The currents drawn on the pump and the electrolysis cell are determined to be constant over this period of time. The switch is then pushed to the “off” position, cutting off current to the pump motor and to the electrolysis cell. The tub water is quickly stirred with a paddle (which has been sterilized to prevent a re-contamination of the treated water) to ensure that the resulting batch of electrolyzed water is homogenous. A third 110 ml sample of the resulting electrolyzed reservoir water 100 (Sample C) is placed into a 125 ml polypropylene bottle with cap for a reading of microbial contamination and residual chlorine in the treated water. The results are shown in Table A.

The number of E coli microorganisms in the 100 ml samples is measured using any one of a number of methods known in the art. For example, U.S. Pat. No. 4,925,789, incorporated herein by reference, describes a suitable test. In addition, the residual chlorine (mixed oxidants) present in the 110 ml sample collected at the outlet of the electrolysis device can be measured using the DPD (N,N diethyl-p-phenylenediamine) Colorimetric Test Method. This method is well known in the art, and is set forth by way of example in International Organization for Standardization, Water Quality, ISO Standard 7393-2:1985, the substance of which is incorporated herein by reference. A suitable DPD reagent for use with the DPD Colorimetric Method is catalog no. 21055-69 manufactured by the Hatch, Company of Loveland, Colo. A suitable colorimeter is model no. DR/890 manufactured by the Hatch Company of Loveland, Colo.

TABLE A

| | Chlorine level, | Microbial count |
|---|---|---|
| Sample | ppm by DPD | (organism/liter) |
| A | 0.0 | >10³ |
| B | 0.6 | none |
| C | 0.12 | none |

The productivity η of the electrolysis cell (from Sample B) as determined by equation I is 400.

A mother may often put her hands into the water, after having touched a bacterially contaminated surface outside the tub. Also, bacteria and other pathogens can inhabit bath sponges, cloths, and even the surface of other play toys. Nevertheless, any object contaminated with bacteria or other pathogen that is introduced into the electrolyzed reservoir solution is immediately sterilized by the continuous electrolyzing action of the device, thereby preventing a re-contamination of the reservoir.

In another embodiment of the invention, a long length tube like the above sampling tube can be attached to the rear port 18 and left in place while the device operates. The discharge of water from the end of the length of tube will cause the discharge end of the tube to move about, and back and forth, like a snake, below the water surface, thereby distributing the cell effluent throughout the reservoir.

Embodiment II

An example of a self-powered self-contained electrolysis device with a close-spaced gap between the electrodes is shown in partial cross section in FIG. 5. FIG. 5 shows an electrolysis device 10 having a self-contained body 12 made into the form of a boat. The body is made from PVC plastic. Mounted on the exterior of the base 16 of the self-contained body is an electrolysis cell 20 of the type shown in FIG. 3 (shown in FIG. 5 in cross section taken through line 5-5 of FIG. 3), having a planar anode plate 21 and a confronting planar cathode plate 22. The anode plate is made of titanium with an iridium oxide coating (0.4 microns thick) and measuring 7.2 cm long and 2.7 cm wide. The cathode plate is made of stainless steel (1.45 mm thick), having the same length and width dimensions as the anode. The cathode plate have a constant gap spacing of 0.40 mm between the two electrodes. An electrical current supply 50 consisting of two “AA” alkaline batteries (each 1.5V) is positioned inside the body, and are wired in series to provide a 3.0V potential current supply across the electrodes. Wires connect the batteries to anode lead 27 and cathode lead 28, which are extending up through the base 16 into the interior of the body 12. The funnel member 86 affixed to the bottom of the cell forces water brought into the funnel opening 87 into the cell passage as the self-contained boat device is moved in direction 90 through the reservoir.

The device can be used to electrolyze water with substantially the same effectiveness as described in Embodiment I for the self-propelled, self-powered buoyant electrolysis device. In the present embodiment, once the device 10 is placed in the reservoir of water, an electric current is established across the pair of electrodes 21 and 22 as water floods into the passage 24. With periodic stirring of the tub water by hand, or movement of the device by hand, or preferably by an extended handle attached to the device (not shown) through the reservoir water for several minutes, sufficient water will pass between the pair of electrodes with the defined spacing to generate an effective level of biocidal mixed oxidants for sterilization of the bath water.

Uses of Electrolyzed Water

The electrolyzed water that exits the electrolysis device 20 can effectively disinfect or sterilize the reservoir water, making the reservoir solution useful as a source of potable water, bathing water, or as a source of sterile water (i.e., water in which microorganism have been neutralized), for manufacturing products or for cleaning manufacturing equipment and for numerous other uses. The electrolyzed reservoir water can also be added to other sources of water to sanitize them (e.g., to neutralize the microorganisms in standing water found in pools, saunas, cooling towers, etc.) Further, the electrolyzed reservoir water can be used to neutralize microorganisms located on organic and inorganic surfaces, body surfaces (e.g., hands, feet, face, etc.), hard and soft surfaces, eating utensils and food contact surfaces, sinks, countertops, faucets, floors, soft surfaces, fabrics, clothing, and other hard and soft surfaces.

A preferred embodiment comprises a device for treating the bath water for babies. Babies require frequent bathing, including the time between the birth and the age of 6 months when the immune system is underdeveloped and susceptible to bacteria and other pathogens. The water in which the baby is bathed can be a significant source of microorganisms that can cause illness, especially diarrhea, by contact with the mucous areas or by unintended ingestion of the bath water by the baby. Sterilization of the bath water before and during the bathing greatly reduces, and can eliminate, illness caused by the bath water.

It is highly preferred to use the electrolyzed reservoir water immediately after the electrolysis, since the beneficial biocidal mixed oxidants have a short life span. Preferably, the reservoir water, when used for disinfection, sanitization or sterilization, is used within about 15 minutes, preferably within about 5 minutes, more preferably within about 1 minute, and most preferably almost immediately, after electrolysis.

The various advantages of the present invention will become apparent to those skilled in the art after a study of the foregoing specification and following claims.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A self-powered, self-propelled, self-contained electrolysis device, for placement into a reservoir of an electrolytic solution containing chloride ions to electrolyze the electrolytic solution, comprising:
(1) a self-contained body,
(2) an electrolysis cell comprising at least a pair of electrodes defining a cell passage formed there between through which the electrolytic solution can flow, the cell passage having an inlet and an outlet, wherein the cell inlet is in fluid communication with the reservoir electrolytic solution,
(3) an electrical current supply for applying electrical current between the electrodes, and
(4) a means of propulsion for moving the self-contained electrolysis device within the reservoir of water.

2. The electrolysis device of claim 1 wherein the electrolysis cell is contained within the self-contained body.

3. The electrolysis device of claim 1 wherein the electrolysis cell is positioned on an outside, submerged surface of the self-contained body, whereby reservoir water passes into the inlet of the electrolysis cell as the self-contained body moves within the reservoir of water.

4. The electrolysis device of claim 1 further comprising a means for pumping the reservoir water through the cell passage.

5. The electrolysis device of claim 1 further comprising an indicator to indicate its functionality.

6. The electrolysis device of claim 5 wherein the indicator is a sensor.

7. The electrolysis device of claim 1 further comprising an indicator to indicate the presence of oxidant species in the water.

8. The electrolysis device of claim 4 wherein the propulsion means is the pumping means.

9. The electrolysis device of claim 8 wherein the pumping means comprises a rotating impeller driven by an electric motor that is powered by an electrical current supply.

10. The electrolysis device of claim 1 further comprising a local source of halide ions, and a means for delivering the local source of halide ions to a portion of the reservoir water in fluid communication with the cell inlet.

11. The electrolysis device of claim 1, wherein said self-contained body is a buoyant body.

12. A self-powered, self-contained electrolysis device, for placement into a reservoir of an electrolytic solution containing chloride ions to electrolyze the electrolytic solution, comprising:
(1) a self-contained body,
(2) an electrolysis cell comprising a pair of electrodes defining a cell passage formed there between through which the electrolytic solution can flow, the cell passage having an inlet and an outlet, wherein the cell inlet is in fluid communication with the reservoir electrolytic solution, and wherein the cell passage forms a gap between the pair of electrodes having a gap spacing between about 0.1 mm to about 5.0 mm, and
(3) an electrical current supply for applying electrical current between the pair of electrodes.

13. The electrolysis device according to claim 12, further comprising a means for pumping the reservoir water to the inlet of the electrolysis cell and through the passage of the electrolysis cell.

14. The self-powered electrolysis device of claim 12, wherein the electrolysis cell is positioned within the self-contained body.

15. The electrolysis device according to claim 12, further comprising a means for manually moving the device through the reservoir solution.

16. The electrolysis device according to claim 12, wherein the electrolysis cell is positioned on the outside of the self-contained body, and the pumping means comprises a funnel member attached to an inlet of the electrolysis cell to move solution through the passage.

17. The electrolytic device of claim 12, further a local source of halide ions, and a means for delivering the localized source of halide ions to a portion of the reservoir water in fluid communication with the electrolysis cell inlet.

18. The self-contained electrolytic device of claim 17 wherein the local source of halide ions comprises a concentrated brine solution or a salt tablet in fluid contact with the reservoir of electrolytic solution.

19. The self-contained electrolytic device of claim 12, wherein said self-contained body is a buoyant body.

20. A method of disinfecting a reservoir of an electrolytic solution containing halide ions with a self-powered electrolysis device, comprising:
1) providing a reservoir of contaminated water;
2) treating at least a portion of the reservoir water with a self-contained electrolysis device, thereby disinfecting the water.

21. The method of claim 20 wherein the reservoir can be repeatedly contaminated with microorganisms, the method further comprising, in response to a re-contamination of the water with microorganisms, the step of re-treating at least a portion of the reservoir water with the electrolysis device, thereby re-disinfecting the water.

22. The method of claim 20 wherein the reservoir of electrolytic solution is continuously treated with the electrolysis device, thereby preventing a re-contamination of the reservoir.

23. The method of claim 22 wherein the reservoir is bath water.

24. The method of claim 22 wherein the reservoir a swimming pool.

25. The method of claim 22 wherein the reservoir is hot tub or spa water.

26. The method of claim 20 wherein the step 2) of treating at least a portion of the reservoir water comprises the steps of:
2a) passing at least a portion of the reservoir water to the electrolysis device,
2b) electrolyzing the portion of reservoir water in an electrolysis cell of the electrolysis device, thereby forming an effluent of electrolyzed water comprising a quantity of mixed oxidant material,
2c) discharging the effluent into the reservoir of water,
2d) dispersing the effluent throughout the reservoir of water, thereby disinfecting the reservoir.

27. The method of claim 26 wherein the step 2b) of electrolyzing the portion of reservoir water comprises the steps of:
i) providing a local source of halide ions,
ii) mixing the local source of halide ions with the portion of the reservoir water passing to the electrolysis cell,
iii) electrolyzing the halide ion-containing water in the electrolysis cell of the electrolysis device, thereby forming an effluent of electrolyzed water comprising a quantity of mixed oxidant material that is greater than a quantity of mixed oxidant material formed by electrolyzing the portion of the reservoir water only.
